(19) United States
(12) Patent Application Publication
(10) Pub. No.: US 2009/0007331 A1
(43) Pub. Date: Jan. 8, 2009

(54) Pet bed with canopy

(76) Inventor: Aaron Lamstein, San Rafael, CA (US)

Correspondence Address: Paul K. Tomita, Suite 1450, Four Embarcadero Center, San Francisco, CA, 94111, US

(21) Appl. No.: 11/824,813

(22) Filed: Jul. 3, 2007

(51) Int. Cl. A01K 29/00

(52) U.S. Cl. 5/418

(57) ABSTRACT

A pet bed sized to receive a domestic pet such as a dog or cat. The bed includes compressible fill material and an outer shell fabric defining the geometry of the bed. The outer shell material includes a bottom fabric, side fabric and top fabric, the top fabric ideally being a plush, high loft material. The bed further includes a collapsible canopy which, when erected, extends over a substantial portion of the top fabric so that when the pet lays upon the bed or cushion, the pet resides beneath at least a portion of the canopy.

### TECHNICAL FIELD OF THE INVENTION

The present invention involves a pet bed or cushion and, specifically, a pet bed for use by domesticated pets such as a dog or cat. The present pet bed includes an appropriate top covering to provide a desirable support surface for the pet together with a collapsible canopy which, when erected, extends over a substantial portion of the top fabric so that when the pet lays upon it, the pet resides beneath at least a portion of the canopy.

### BACKGROUND OF THE INVENTION

Pet beds are currently available in a multitude of sizes and shapes together with a variety of fill materials. Such beds can be fairly large, intended for use by large dogs, or fairly small, for use by a single domestic cat. In most instances, these beds include an outer fabric that defines the geometry of the pet bed thus presenting to the pet a rather soft plush surface to encourage lounging and sleeping.

It has been found that there are instances in which pets, for a variety of reasons, do not take full advantage of beds specifically designed for pet use. For example, some pets, such as certain canine varieties, enjoy sleeping and lounging in an enclosed area harkening back to a predisposition created by their ancestral chain in which dogs were cave dwellers and found safety and comfort in enclosed spaces. Further, some cats enjoy the perceived safety of an enclosed space or barrier and do not feel comfortable if fully exposed to passersby particularly when sleeping. In addition, in situations in which the bed is exposed to sunlight, such as, through a window, pets may leave the bed to a different location to avoid direct sunlight, particularly on a hot day.

It is thus an object of the present invention to provide a pet bed capable of overcoming the disadvantages as provided above.

As a further object of the present invention to provide a pet bed which recognizes the needs of domestic pets and creates a means of satisfying such needs.

These and further objects will be more readily apparent when considering the following disclosure and appended drawings.

### SUMMARY OF THE INVENTION

The present invention is directed to a pet bed sized to receive a domestic pet such as a cat or dog. The pet bed comprises compressible fill material and an outer shell fabric defining the geometry of the pet bed. The outer shell comprises bottom fabric, side fabric and top fabric and the bed further includes a collapsible canopy which, when erected, extends over a substantial portion of the top fabric so that the pet lays upon it, the pet resides beneath at least a portion of the canopy.

### BRIEF DESCRIPTION OF THE FIGURES

FIG. 1 is a perspective view of the pet bed of the present invention.

FIG. 2 is a side plan view of the pet bed of the present invention showing the canopy of the pet bed in a folded state.

### DETAILED DESCRIPTION OF THE INVENTION

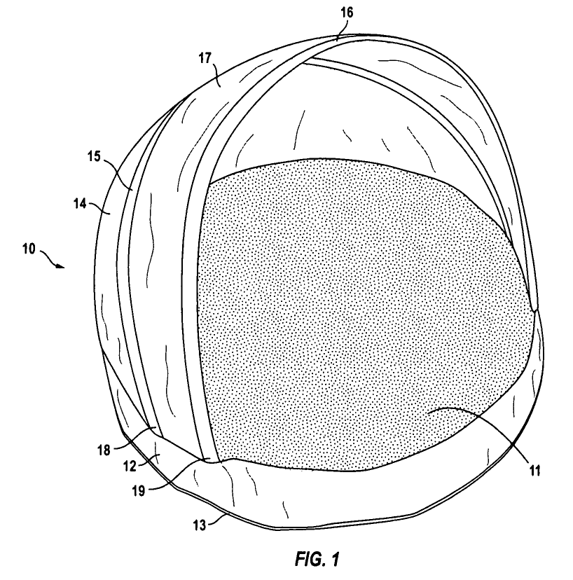

Turning to FIG. 1, pet bed 10 is shown sized to receive a domestic pet such as a cat or dog. The pet bed includes a compressible fill material such as memory foam, straw, polyester fiber cotton or wool batting in order to provide a compressible and comfortable product to encourage the pet to use bed 10 for lounging and sleeping. Further to this end, bed 10 includes not only bottom fabric 13 and side fabric 12, but also top fabric 11 which, in its preferred embodiment, should be a plush, high loft material.

Pet bed 10 also includes canopy 14 which, in its erected state as shown in FIG. 1, is sized to extend over a substantial portion of top fabric 11 such that when a domestic pet resides upon top fabric 11, the pet will reside at least partially beneath canopy 14. As such, pet bed 10 provides to a pet the security of an enclosure together with potential for sheltering the pet from environmental conditions, such as strong sunlight and even rain.

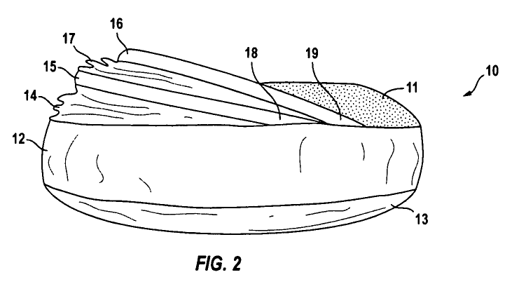

As a further expedient, it is contemplated that canopy 14 be collapsible as shown in FIG. 2. In doing so, frame members 15 and 16 which support canopy fabric 17 can be caused to pivot at points 18 and 19 enabling canopy 14 to lie against top fabric 11, again, as shown in FIG. 2. Ideally, collapsible canopy 14 includes a plurality of flexible supports such as bowed slats or tubing 15 and 16 appended to the pet bed at their distal ends, that is, at pivot points 18 and 19 to provide for a tensioning of fabric 17.

The foregoing description is for purposes of illustration only and is not intended to limit the scope of protection accorded this invention. The scope for protection is to be measured by the following claims, which should be interpreted as broadly as the inventive contribution permits.

1. A pet bed, sized to receive a domestic pet such as a cat or dog, said pet bed comprising compressible fill material and an outer shell fabric defining the geometry of the pet bed, said outer shell comprising bottom fabric, side fabric and top fabric and a collapsible canopy which when erected, extends over a substantial portion of said top fabric such that when said domestic pet lays upon said top fabric, it will at least partially be beneath said canopy.

2. The pet bed of claim 1 wherein said top fabric is a plush, high loft fabric.

3. The pet bed of claim 1 when said canopy is collapsible to fold, in its collapsed state, substantially against said top fabric.

4. The pet bed of claim 1 wherein said canopy comprises a collapsible frame and a canopy fabric being attached thereto.

5. The pet bed of claim 4 wherein said collapsible frame comprises a plurality of bowed slats appended to said pet bed at their distal ends to provide support for tensioned canopy fabric.
